(19) United States
(12) Patent Application Publication
(10) Pub. No.: US 2017/0255752 A1
(43) Pub. Date: Sep. 7, 2017

(54) CONTINUOUS ADAPTING SYSTEM FOR MEDICAL CODE LOOK UP

(71) Applicant: Artificial Medical Intelligence, Inc., Eatontown, NJ (US)

(72) Inventors: Andrew B. Covit, East Brunswick, NJ (US); Stuart Covit, Marlboro, NJ (US); Mark Elliott Familant, Tinton Falls, NJ (US)

(73) Assignee: Artificial Medical Intelligence, Inc., Eatontown, NJ (US)

(21) Appl. No.: 15/449,345

(22) Filed: Mar. 3, 2017

Related U.S. Application Data
(60) Provisional application No. 62/303,056, filed on Mar. 3, 2016.

(51) Int. Cl. G06F 19/00; G06F 17/30

(52) U.S. Cl. CPC G06F 19/325; G06F 17/30952; G06F 17/30985; G06F 17/30867

(57) ABSTRACT

Aspects of the disclosure relate to a computer implemented method for searching a medical coding database. The method may include receiving a particular look-up term associated with a particular medical classification code. The particular look-up term may contain one or more words. The method may include creating a set of indices derived from the particular look-up term. Each index in the set of indices may include a string containing at least three contiguous characters from the particular look-up term. The first character of the string may be the first character of one of the one or more words of the particular look-up term. The method may include associating each index in the set of indices to the particular medical classification code. The method may include storing the set of indices and the associated particular medical classification code into an indexing table of the medical coding database.

### CROSS-REFERENCE TO RELATED APPLICATIONS

This application claims the benefit of the filing date of U.S. Provisional Patent Application No. 62/303,056 filed Mar. 3, 2016, the disclosure of which is hereby incorporated herein by reference.

### BACKGROUND

Medical data requires various medical codes for billing, diagnostic use, etc. For example, ICD (International Statistical Classification of Diseases) codes are used for classification of medical conditions, diseases, etc. CPT® (Current Procedural Terminology) codes are used to classify medical services, procedures, etc. There are over 141,000 ICD-10 codes and approximately 7800 CPT® codes. The medical clinician who needs to use these codes in various medical technology systems is faced with the daunting task in a variety of clinical settings, including ambulatory or bedside scenarios, of selecting from amongst these codes the small subset that applies to a particular context For example, a context could be a particular medical state of a patient or a particular instance of medical documentation. Looking up a medical code in a computer implemented medical codes database is a much more difficult task than looking up a word in a dictionary. The words in a natural language are reasonably well defined and most commercial dictionaries provide a near exhaustive list of the words that might be used to look-up definitions by most users.

In the case of medical codes, there may be a set of medical terms that are associated with a medical condition or procedure. These medical terms are used to look-up the corresponding medical codes in a similar way a word is used to look-up a definition in a conventional dictionary. Although there is an official corpus of medical terminology that had been used in constructing a medical code set, the terminology may not be widely used in everyday routine practice. Clinical practitioners instead employ a large range of terms when referring to medical conditions and procedures beyond the standard corpus and this is reflected in the clinical documentation that they generate. Clinical practitioners may use unique terms such as unique words, acronyms, phrases, slangs, etc. in their day to day activities to describe diseases and procedures. The decision to use a specific term may depend on the context, working environment, disease state, technical system or sites used, source of the clinical documents, etc. These terms may not be part of the standard nomenclature or the official medical corpus terminology for a given disease or procedure. This greatly complicates and slows down the look-up process in a computer implemented medical technology system, especially one which does not account for the usage of unique terms. For clinical users to find the correct code in such a system, the words or phrases they are thinking of or the words or phrases they find in the clinical documentation should somehow match, at least partially, the official descriptions in the medical corpus. Exact matches almost never happen and partial matches result in complicated look-up strategies involving generation of synonyms for initial descriptions and slowly eliminating alternatives until the correct code or codes are found. Errors in code look-up are inevitable as is evidenced by the frequently cited error rates amongst medical coders of 20 to 30 percent. Therefore, there is a need for reducing errors in and improving efficiency of computer implemented medical codes searching, retrieval, and display associated with medical codes databases.

### BRIEF SUMMARY

The present technology provides for a system and method for reducing errors in searching a medical coding database.

The disclosure provides for a method implemented on a non-transitory readable storage medium to control a processor for searching a medical coding database. The method may include receiving a particular look-up term associated with a particular medical classification code. The particular look-up term may include one or more words. The method may include creating a set of indices derived from the particular look-up term. Each index in the set of indices may include a string containing at least three contiguous characters from the particular look-up term. The first character of the string may be the first character of one of the one or more words of the particular look-up term. The method may include associating each index in the set of indices to the particular medical classification code. The method may include storing the set of indices and the associated particular medical classification code into an indexing table of the medical coding database.

Additionally, the method may include retrieving at least one resulting medical classification code in response to an input received through a client interface. The input may equal to at least one matching index in the indexing table and the at least one resulting medical classification code may be associated with the at least one matching index.

In some example, the method may further include displaying the at least one resulting medical classification code on the client interface. Optionally, historical usage data may be used to control the order of display of the at least one resulting medical classification code on the client interface. In one version, the indexing table may include a many-to-many relationship between indices and medical classification codes.

The method may further include, prior to receiving the particular look-up term, storing the particular look-up term in a medical coding corpus. Additionally, prior to storing the particular look-up term in the medical coding corpus, the method may further include collecting a set of candidate look-up terms. The set of candidate look-up terms may include the particular look-up term. In addition, collecting the set of candidate look-up terms may include associating candidate medical classification codes to the set of candidate look-up terms. The set of candidate look-up terms may be associated to candidate medical classification codes using a medical document.

The method may further include applying a first filter configured to determine whether a combination of the particular look-up term and the particular medical classification code does not exist in the medical coding corpus. The method may further include applying a second filter configured to determine whether a combination of the particular look-up term and the particular medical classification code was not previously rejected as candidate combination. In addition, the second filter may use a rejection table comprising previously rejected combinations of candidate look-up terms and candidate medical classification codes. The method may further include applying a third filter configured to determine whether a combination of the particular look-up term and the particular medical classification code is valid.

The disclosure further provides for an automated system for searching a medical coding database. The system may include one or more processors and a memory accessible by the one or more processors. The memory may include instructions executable by the one or more processors. The instructions may be configured to receive a particular look-up term associated with a particular medical classification code. The particular look-up term may include one or more words. The instructions may be configured to create a set of indices derived from the particular look-up term, wherein each index in the set of indices comprises a string containing at least three contiguous characters from the particular look-up term. The first character of the string may be the first character of one of the one or more words of the particular look-up term. The instructions may be configured to associate each index in the set of indices to the particular medical classification code. The instructions may be configured to store the set of indices and the associated particular medical classification code into an indexing table of the medical coding database.

The automated system may include instructions further configured to retrieve at least one resulting medical classification code in response to an input received through a client interface. The input may equal to at least one matching index in the indexing table and the at least one resulting medical classification code may be associated with the at least one matching index.

In one version, the instructions may be further configured to display the at least one resulting medical classification code on the client interface. Additionally, historical usage data may be used to control the order of display of the at least one resulting medical classification code on the client interface. Furthermore, the indexing table may include a many-to-many relationship between indices and medical classification codes.

The disclosure further provides for a non-transitory computer readable storage medium comprising instructions executable by one or more processors for searching a medical coding database. The instructions may be executable to receive a particular look-up term associated with a particular medical classification code. The particular look-up term may include one or more words. The instructions may be executable to create a set of indices derived from the particular look-up term. Each index in the set of indices may comprise a string containing at least three contiguous characters from the particular look-up term. The first character of the string may be the first character of one of the one or more words of the particular look-up term. The instructions may be executable to associate each index in the set of indices to the particular medical classification code. The instructions may be executable to store the set of indices and the associated particular medical classification code into an indexing table of the medical coding database.

Additionally, the non-transitory computer readable storage medium may further include instructions executable by one or more processors to retrieve at least one resulting medical classification code in response to an input received through a client interface. The input may equal to at least one matching index in the indexing table and the at least one resulting medical classification code may be associated with the at least one matching index.

### BRIEF DESCRIPTION OF THE DRAWINGS

FIG. 1 is a functional diagram of an example system in accordance with aspects of the disclosure.

FIG. 2 is an example system diagram in accordance with aspects of the disclosure.

FIG. 3 is an example collection subsystem in accordance with aspects of the disclosure.

FIG. 4 is an example filtering subsystem in accordance with aspects of the disclosure.

FIG. 5 is an example user interface display in accordance with aspects of the disclosure.

FIG. 6 is an example flow diagram in accordance with aspects of the disclosure.

FIGS. 7-8 are example tables in accordance with aspects of the disclosure.

FIG. 9 is an example indexing subsystem in accordance with aspects of the disclosure.

FIG. 10A-10B are examples of a retrieval subsystem in accordance with aspects of the disclosure.

FIG. 11 is an example flow diagram in accordance with aspects of the disclosure.

### DETAILED DESCRIPTION

The present disclosure relates to a computer implemented method, system, and computer-readable storage medium for reducing errors in searching medical codes database. Because the terms that a user may employ when looking up a medical code in a medical codes database vary greatly, any effective solution should be able to accept a wide variety of words or phrases as input. This set of look-up terms should also be easily and quickly changeable to reflect differences in language use that occur across facilities and across time. Incorporation of new look-up terms should include a validation process so that errors do not get introduced into the look-up terms. A flexible system of look-up should offer alternatives from the coding corpus based on all entries in the corpus that match, even partially the user's input. The technology described herein considers these needs.

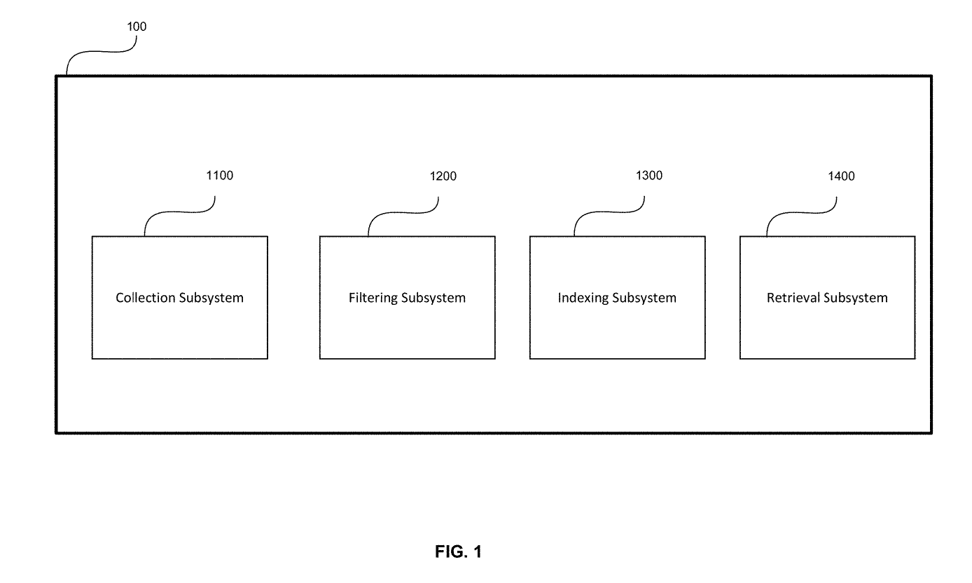

An example system includes one or more subsystems. For example, FIG. 1 depicts a system 100 including several such subsystems. It will be understood by those of ordinary skills in the art that the subsystems and components within the subsystems may or may not reside within the same physical or functional module.

A Collection Subsystem. This system harvests candidate look-up terms. The look-up terms may be a byproduct of a computer assisted coding system. The look-up terms may also be collected from external medical technology systems and healthcare related sites. For example, FIG. 1 depicts system 100 having a collection subsystem 1100.

A Filtering Subsystem. This system applies several automated determinations, including a consensus driven methodology, to the candidate terms to determine which ones are valid look-up entries for associated codes. For example, FIG. 1 depicts system 100 having a filtering subsystem 1200.

An Indexing Subsystem. This system generates keys (fragments of the look-up terms) that can be used to retrieve codes. For example, FIG. 1 depicts system 100 having an indexing subsystem 1300.

A Retrieval Subsystem. This system uses the extensive indexing to allow retrieval of candidate medical codes based on user input, even if that input only partially matches associated lookup terms or matches multiple terms. For example, FIG. 1 depicts system 100 having an indexing subsystem 1400.

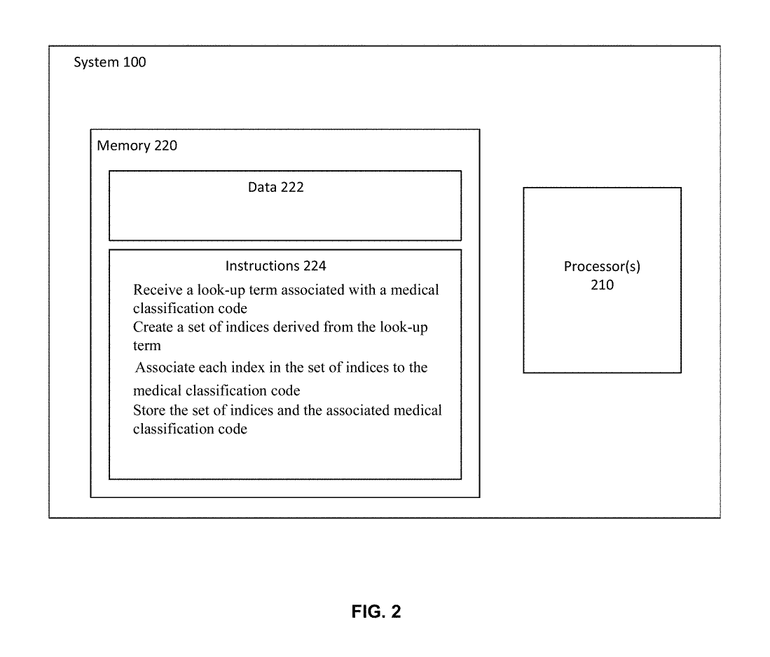

FIG. 2 generally illustrates one possible system 100, in which aspects disclosed herein may be implemented. System 100 may be a computing device containing one or more processors 210, memory 220, and other components typically present in computing devices. Although FIG. 2 represents processors 210 and memory 220 within the same functional block, one skilled in the art will understand that the system may include and the methods disclosed herein may involve multiple processors, memory, devices, and components that may or may not be stored within the same physical module.

Memory 220 may include data 222 and instructions 224. Memory 220 may store information accessible by processors 210. Memory 220 may be any type of medium capable of storing information accessible by a relevant processor. Memory 220 may be a non-transitory computer readable storage medium. The instructions 224 may be any set of instructions executable by different subsystems of system 100. The instructions 224 may be executed by processors 210 or other relevant processors. Data 222 may represent any type of data retrievable by instructions 224. Data 222 may include look-up terms and medical codes in accordance with the disclosure herein. Data 222 may also include data in a medical coding database in accordance with the disclosure herein. Data 222 may also include data in any type of data structure capable of storing information.

The Collection Subsystem

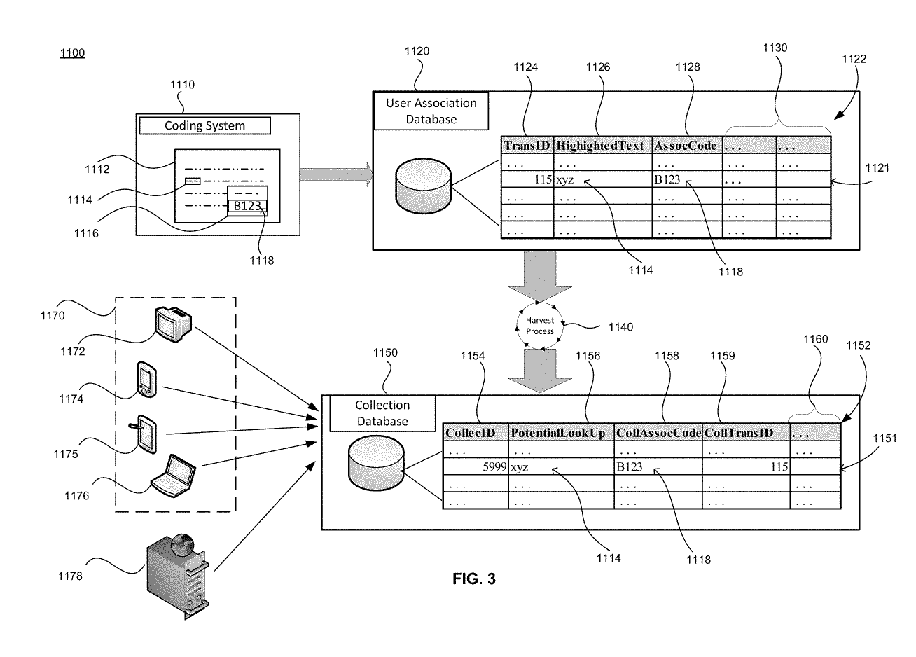

The collection subsystem collects candidate look-up terms for medical codes. As an example, collection subsystem 1100 is depicted in FIG. 3. The collection subsystem may collect potential look-up terms from various sources. The potential look-up terms may be used to build a comprehensive dictionary to associate unique terms clinical practitioners may use to describe diseases and procedures. The unique terms may include unique words, acronyms, phrases, slangs, etc. The usage of a specific term may depend on the context, clinical environment, disease state, clinical setup, technical system or sites used, source of the clinical documents, etc. The collection subsystem collects these unique terms, which may not be part of the standard nomenclature or the official medical corpus terminology for a given disease or procedure, and assimilates the terms in a comprehensive dictionary to associate with medical codes.

Candidate look-up terms captured by the collection subsystem are used to define at a grass roots level a particular disease state. Even though the candidate look-up terms may not be commonly defined or standard nomenclature, these terms may become part of the overall unique mapping schema in the comprehensive dictionary. This may be attributable to the working environment of the clinical practitioner. This mapping is later assimilated into the functions of the indexing and retrieval subsystem for providing robust dynamic searching capabilities. This process provides medical terminology advantage due to the fact that the system assimilates area-specific and/or facility-specific terms of medical communications, and translates those unique letters, phrases, and slangs so that they become scanable, searchable useful terminology for future reference for mapping to a particular coding system, such as the ICD10.

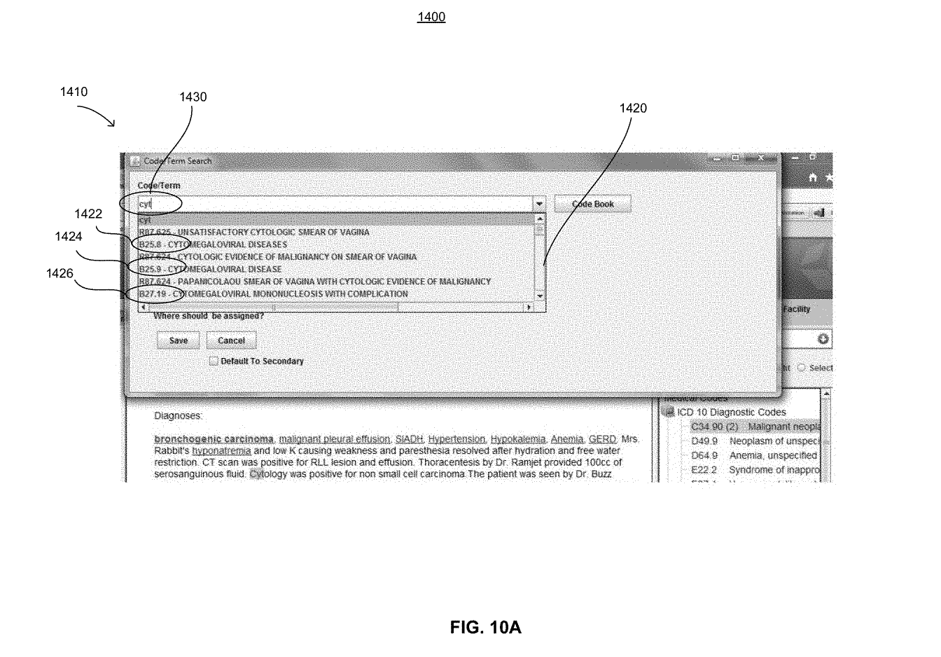

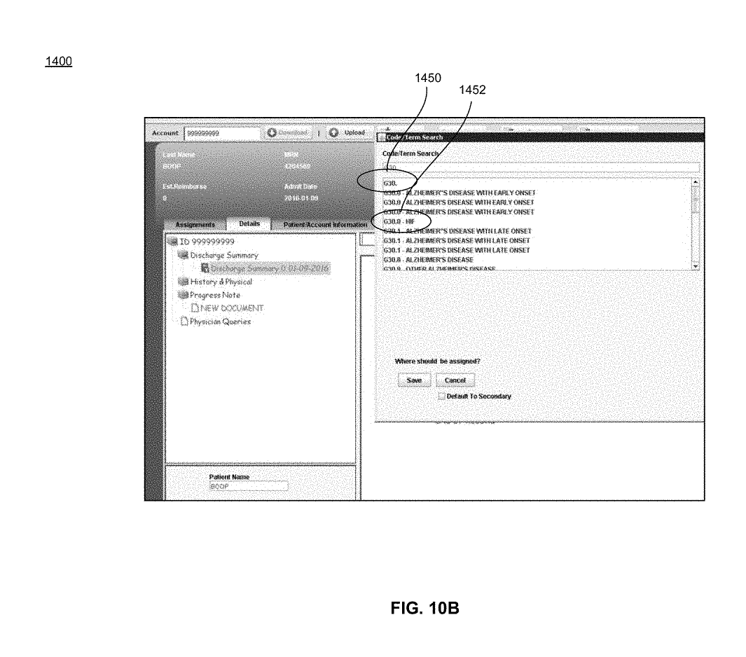

For example, a physician may use a site specific terminology “Decreased HIF” to describe a disease that is ordinarily associated with “dementia” or a code “G30.0” that has a standard definition “Alzheimer's disease with early onset.” The collection subsystem collects this site specific term “Decreased HIF” to associate with code “G30.0” in its comprehensive dictionary. In a system without this assimilation, looking up the term “HIF” would not successfully provide the intended result of “G30.0 Alzheimer's disease with early onset,” as shown later in FIG. 10B with respect to the retrieval subsystem.

The candidate look-up terms may be collected from connected medical technology systems, or even non-connected external systems where a communication link may be setup to collect data from. The connected or non-connected systems may be systems that physicians and healthcare workers use in their day to day healthcare activities. As a result, terms that are not ordinarily part of a standard coding corpus may become available for use with a comprehensive dictionary in order to interpret and assimilate with medical codes.

In one example, the collection subsystem may be configured to allow users to highlight text and associate the text with a medical code as part of the processing of applying medical codes to clinical documentation, such as, in a user interface of the system. For example, as shown in FIG. 3, a user may use coding system 1110 to process a medical document 1112. The user highlights text 1114 and associates text 1114 to a medical code 1118 using the prompt 1116. When a user creates an association this way, the system automatically annotates the highlighted text, and associated code as added by a user in an associated database. For example, as shown in FIG. 3, collection subsystem 1100 uses the user association database 1120 to store the user's association. The user association database 1120 may contain a table 1122 with columns TransID 1124, HighlightedText 1126, AssocCode 1128, and other columns 1130. Highlighted text 1114 is inserted into column HighlightedText 1126 and medical code 1118 is inserted into column AssocCode 1128 in row 1121 on table 1122. The table may also store other relevant data, such as context data, user ID, document ID, facility ID, etc. in columns 1130.

A harvest process collects the codes, text, and associated clinical context on a regular schedule and stores it such as in a separate database table. The text associated with the code constitutes a potential look-up term. For example, as shown in FIG. 3, harvest process 1140 is run on a regular schedule to collect data from user association database 1120. The collected data is stored in collection database 1150, which contains a collection table 1152 with columns CollecID 1154, PotentialLookUp 1156, CollAssocCode 1158, CollTransID 1159, and other columns 1160. The harvesting process inserts highlighted text 1114 into column PotentialLookUp 1156 and medical code 1118 is inserted into column CollAssocCode 1158 on table 1152 in row 1151 In one embodiment, to reduce costs in generating these candidates, the current solution may exploit an existing computer aided coding system, such as a feature of the Computer Aided Coding (CAC) system of Artificial Medical Intelligence (AMI), the disclosure of which is hereby incorporated herein by reference to the U.S. patent application Ser. No. 11/106,817 filed Apr. 15, 2005. The collection subsystem may be part of each installation of a computer aided coding system, so the collection process described above occurs in numerous hospitals, billing centers, and other medical facilities. For example, FIG. 3 shows various computer aided systems 1170 collecting candidate look-up terms. The systems may represent a billing center computer 1172, a physician's PDA 1174, a technician's tablet 1175, a hospital laptop 1176, etc. These systems 1170 may collect and send candidate look-up terms data to collection database 1150 on a regular schedule, as described above. The collection subsystem may also use external medical technology systems and healthcare related sites for collecting potential look-up terms. For example, FIG. 3 includes an external medial web server 1178 where the potential terms may be collected from.

The Filtering Subsystem

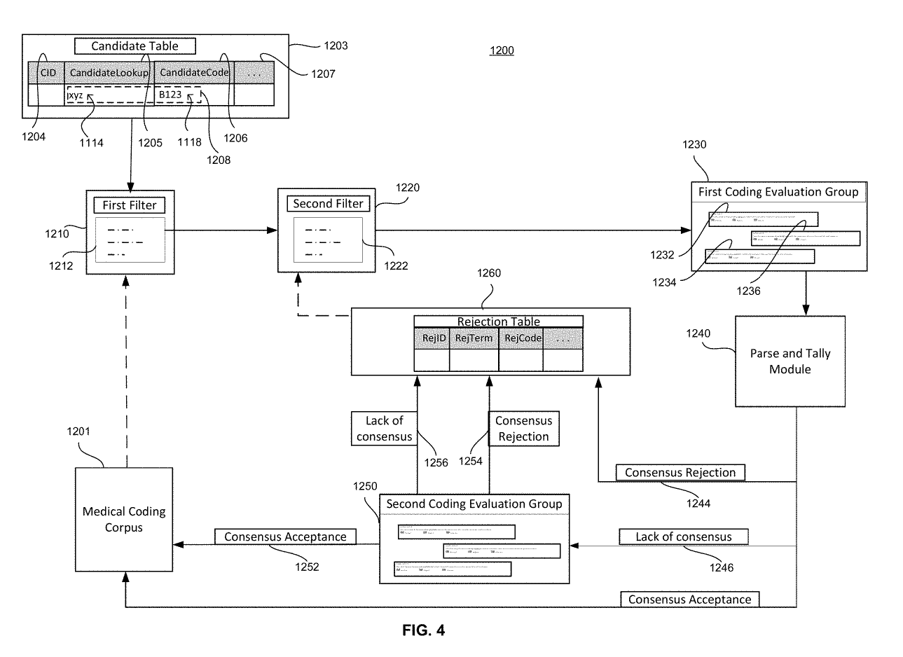

The filtering subsystem screens candidate look-up terms. As an example, filtering subsystem 1200 is depicted in FIG. 4. In one embodiment, the filtering subsystem may use a medical coding corpus. For instance, the filtering subsystem may use the AMI corpus. The first filter determines if the current look-up term code combination already exists in the current AMI corpus. If it does, it is removed as a candidate. This is an automated process performed by a database script. For example, as shown in FIG. 4, filtering subsystem 1200 uses a candidate table 1203 containing columns CID 1204, CandidateLookup 1205, CandidateCode 1206, and other columns 1207. Candidate table 1203 may contain a candidate term code combination 1208 with highlighted text 1114 as a candidate look-up term and medical code 1118 as a candidate code. First filter 1210 is applied on the combination 1208 using a database script 1212. Using medical coding corpus 1201, first filter 1210 determines if combination 1208 already exists in corpus 1201. If it already exists, then combination 1208 is removed as a candidate.

If the candidate term code combination does not exist in current corpus, then a second filter determines if this candidate term code combination has previously been rejected. If it has, it is eliminated as a candidate. For example, in FIG. 4, second filter 1220 is applied on combination 1208 using script 1222 and rejection table 1260. If combination 1208 already exists in rejection table 1260, it has been previously rejected, and thus the combination 1208 is eliminated as a candidate.

If the candidate combination is not eliminated, a third filter may use an automated system to solicit feedback from human coders on the validity of the look-up term code combination. For instance, to solicit coder feedback, the filtering subsystem 1200 may use AMI's Delphi Method For Medical Coding, the disclosure of which is hereby incorporated herein by reference to the U.S. patent application Ser. No. 12/519,899 filed Dec. 20, 2007.

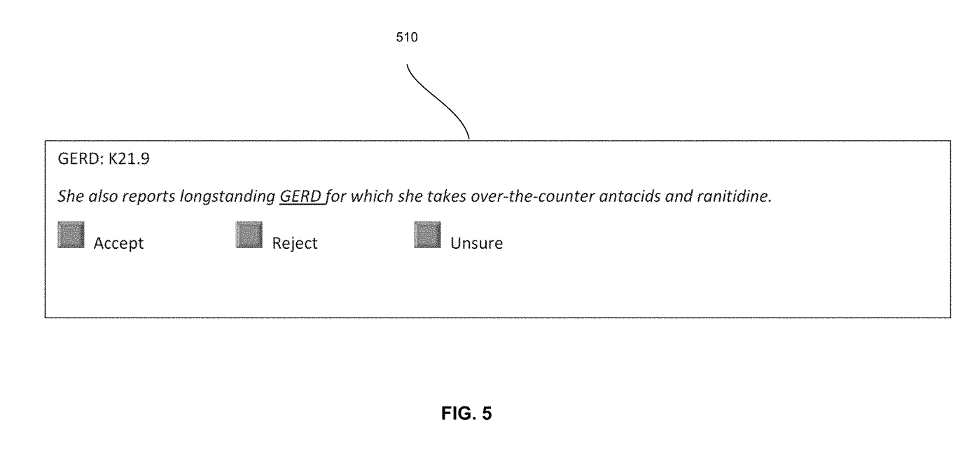

When the third filter is applied, a process automatically formats identical emails to each member of a medical coding evaluation group. Each group consists of three or more medical coders. The coders receive a form with the look-up term and code combination along with some of the context in which the combination occurs. FIG. 5 shows an example of a portion of one of these forms 510. Referring back to FIG. 4, for example, first coding evaluation group 1230 consist of three medical coders, and each receives a form 1232, 1234, and 1236, respectively, containing combination 1208.

Once a form is completed, it is sent to a processing module, such as a system mailbox, where it is automatically parsed and tallied. A consensus opinion of acceptances results in the candidate being automatically inserted into the coding corpus dictionary. For example, the AMI dictionaries may be used as the coding corpus dictionary. A consensus rejection results in the code look-up term combination being stored in a rejection table which forms the basis of one of the filters described above. A tie or a lack of consensus results in a look-up term and code pair being sent to a second code evaluation group. If the second group is also unable to obtain a consensus, the pair is rejected. For example, as shown in FIG. 4, forms 1232, 1234, and 1236 are sent to parse and tally module 1240 for the results of the forms to be analyzed. If the results indicate a consensus opinion of acceptance of the look-up term and code combination 1208, combination 1208 is inserted into a dictionary in medical coding corpus 1201, as indicated by arrow 1242. However, if the results from module 1240 indicate a consensus opinion of rejection of the combination 1208, then the combination is inserted in rejection table 1260, as indicated by arrow 1244. If there is no consensus among the coders regarding combination 1208, or if the results are tied, then the combination is sent to second coding evaluation group 1250. A lack of consensus, as indicated by arrow 1256, or a consensus rejection, as indicated by arrow 1254, results in the combination 1208 being inserted in rejection table 1260. A consensus acceptance from group 1250 results in combination 1208 being inserted into a dictionary in medical coding corpus 1201, as indicated by arrow 1252.

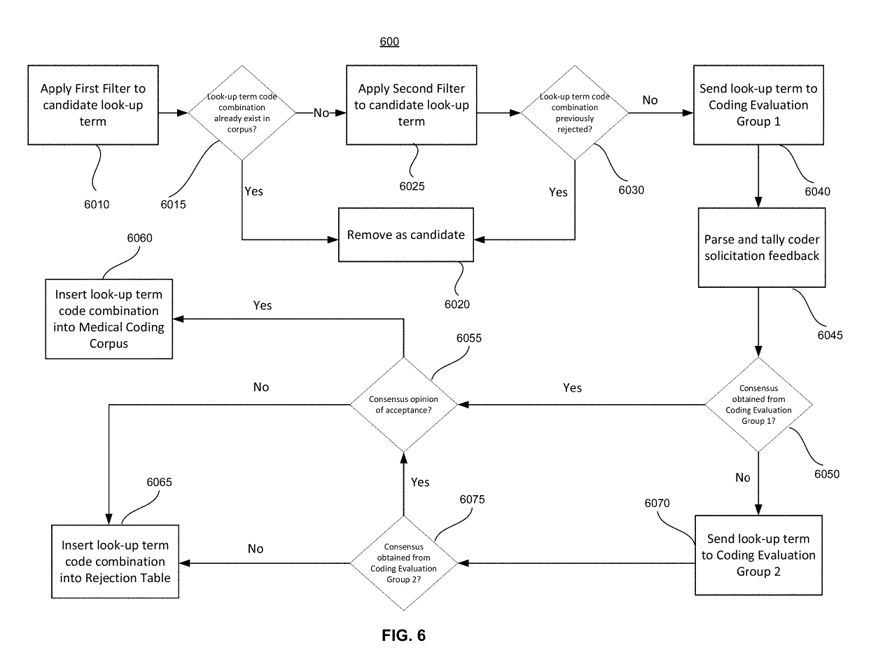

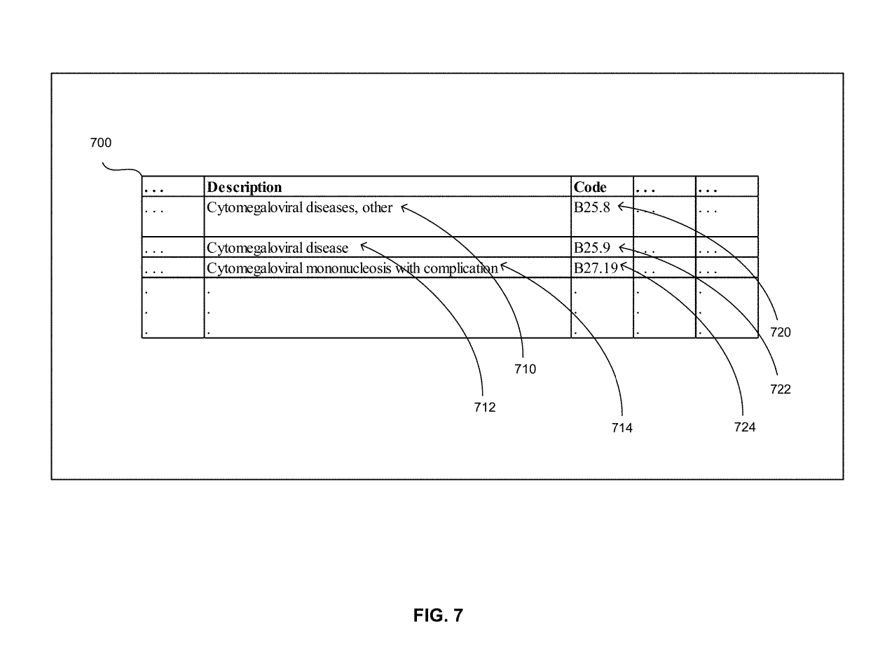

Turning to FIG. 6, a general flowchart of the filtering subsystem functions are shown. In block 6010, a first filter is applied to a candidate look-up term and code combination. In some examples, the filter is applied using a medical coding corpus, such as the AMI corpus. Any script, such as a database script as noted above, may be used to apply the first filter. In block 6015, it is determined whether a candidate look-up term code combination already exists in the medical coding corpus. If the combination already exists in the corpus, then the combination is to be removed as candidate in block 6020. If the combination does not exist in coding corpus, then a second filter is applied to the candidate combination in block 6025. In some examples, the filter may be applied using a script, such as a database script.

In block 6030, it is determined whether the candidate combination was previously rejected. In some examples, a rejection table is used for this determination. If it is determined that the combination was previously rejected, the combination is removed as a candidate in block 6020. If the combination was not previously determined, a third filter is applied to the combination to solicit feedback from human coders by sending the combination to coding evaluation group 1 in block 6040. The results of the evaluation is parsed and tallied in block 6045.

In block 6050, it is determined whether a consensus is obtained from coding evaluation group 1. If a consensus is obtained, in block 6055, it is determined whether the consensus opinion is of acceptance of the candidate combination. If it is determined that the opinion is of acceptance, then the candidate combination is inserted into the medical coding corpus in block 6060. However, if in block 6055 it is determined that the consensus opinion was not of acceptance, rather rejection, then the combination is inserted into the rejection table.

In block 6050, if it is determined that consensus is not obtained from coding evaluation group 1, then the look-up term code combination is sent to coding evaluation group 2 in block 6070. The results of the evaluation is again parsed and tallied. In block 6075, it is determined whether a consensus is obtained from coding evaluation group 2. If consensus is obtained, it is determined whether the consensus opinion is of acceptance of the candidate combination, as described above in relation to block 6055. Similarly, if it is determined that the opinion from coding evaluation group 2 is of acceptance, then the candidate combination is inserted into the medical coding corpus, as described in relation to block 6060. However, if in block 6075 it is determined that no consensus opinion was obtained, then the combination is inserted into the rejection table.

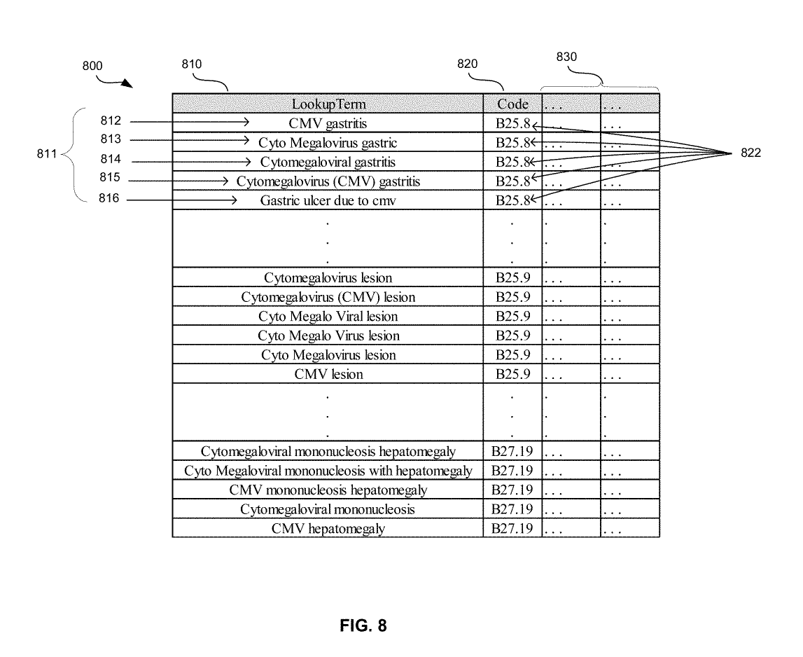

However, the two subsystems described above, the collection subsystem and the filtering subsystem, may result in a many-to-one coding set where each entry may consist of many to one mappings between sets of look-up terms and an associated code. For example, FIG. 8 shows a many-to-one mapping between sets of look-up terms and associated code. In FIG. 8, a code look-up mapping table 800 is depicted. Table 800 may contain columns LookupTerm 810, Code 820, and other columns 830, etc. There may be additional relevant data entries in columns 830, such as IDs, historical usage data, etc. In this mapping table 800, a set 811 of multiple look-up terms 812, 813, 814, 815, and 816 maps to a single associated code 822.

Changing the system from a one-to-one map to a many-to-one map significantly improves the likelihood that any given description will match at least one association between a look-up term and a code. The reason for this is that the user has more chances of entering a look-up term which maps to a code in the coding set.

The Indexing Subsystem

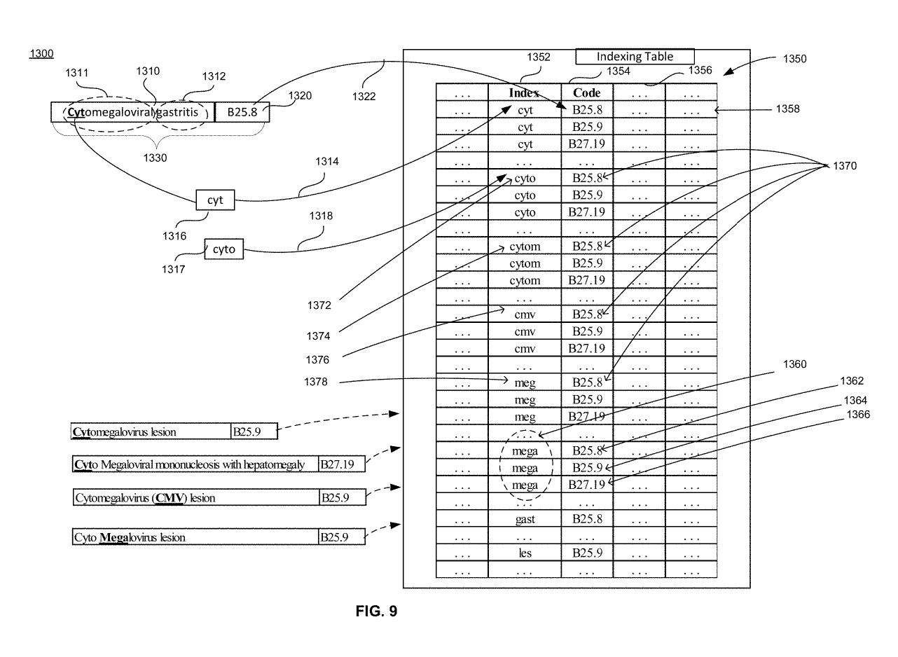

The display and retrieval functionalities in a computer implemented medical technology system may be further enhanced by extensive indexing relating to medical codes. As an example, indexing subsystem 1300 is depicted in FIG. 9. Indexing creates a map between text strings and code entries. The mapping may be a many-to-many map with a single entry in the index corresponding to multiple codes and a single code corresponding to multiple entries in the index. In this system, the index consist of ordered strings derived from the look-up terms such that each string consists of a set of three or more contiguous characters from a look-up term where the first character is the first character of one of the words of the look-up term.

For example, as shown in FIG. 9, indexing subsystem 1300 receives a look-up term 1310. In one example, look-up term 1310 may be received from a medical coding corpus. The medical coding corpus may be the medical coding corpus 1201 depicted in FIG. 4 in relation to the filtering subsystem 1200. Lookup-term 1310 may be associated with a medical code 1320. In one example, look-up term code combination 1330 derived from look-up term 1310 and medical code 1320 may be a combination from the medical coding corpus 1201, such as combination 1208.

In FIG. 9, look-up term 1310 consists of two words, a first word 1311 and a second word 1312. An ordered string 1316 is derived from first word 1311. String 1316 consists of a set of three contiguous characters from first word 1311 of the look-up term 1310. The first character of string 1316 is the first character of first word 1311. The indexing subsystem associates string 1316 with medical code 1320. In further examples, another string 1317 may be derived from first word 1311 which contains a set of four contiguous characters from the first word. The indexing subsystem also associates string 1317 with medical code 1320. A set of strings may be derived in such manner, where the strings are all associated with medical code 1320.

An ordered string may be stored into an indexing table of the indexing subsystem as an index. The associated medical code may also be stored into the indexing system. Similarly, a set of ordered strings may be stored into the indexing table as a set of indices. The set of strings may be associated with a particular medical code.

As shown in FIG. 9, indexing subsystem 1300 includes indexing table 1350. Indexing table 1350 may contain columns Index 1352, Code 1354, and other columns, such as column 1354, which may store various relevant data, such as IDs, standard description, context, historical usage data, etc. The set of strings derived from look-up term 1310 may be stored in indexing table 1350. For example, string 1316 is stored as an index in column Index 1352 in row 1358, as indicated by arrow 1314. Medical code 1320, which is associated with look-up term 1310, is also stored in indexing table 1350, as indicated by arrow 1322, in the same row 1358. Similarly, other strings, such as string 1317, are stored in column Index 1352 as derived from look-up term 1310. The set of strings 1316 and 1317 is stored in table 1350 as a set of indices associated with medical code 1320.

As shown in FIG. 9, a single entry 1360 in the Index 1352 column corresponds to multiple codes 1362, 1364, and 1366. On the other hand, a single code 1370 corresponds to multiple entries 1372, 1374, 1376, 1378, etc. in the index. Thus, a many-to-many mapping relationship is established between the indices and the medical codes.

In another embodiment, the first character of the ordered string may be the second character of one of the words of the look-up term. In a different embodiment, the first character of the ordered string may be the n^{th} character of one of the words of the look-up term, wherein n may range from 1 to M−2 and M is the number of characters in the word which the string is derived from. In a different embodiment, the string may consist of a set of two or more contiguous characters from a look-up term where the first character is the m^{th} character of one of the words of the look-up term, where m may range from 1 to M−1 and M is the number of characters in the word which the string is derived from.

The indexing subsystem may also process look-up terms by removing extraneous characters to derive substantive terms for use with an index. For example, the indexing subsystem may remove characters such as “(” or “,” from a look-up term.

Indexing significantly increases the likelihood that a computer implemented technology system will be able to match one or more codes to a user's entry accurately and fast. It allows a retrieval system to employ a narrowing strategy in which the number of retrieved entries becomes smaller as the user types more information.

The Retrieval Subsystem

The Retrieval Subsystem allows different clients to communicate with a server for the purposes of retrieving medical codes based on user entered input through a standardized interface. As an example, retrieval subsystem 1400 is depicted in FIGS. 10A-B. A user through a client starts typing characters, when at least three characters are entered, all code entries in the code set with associated indices that match what is typed are retrieved for the purposes of displaying them to a user. The user sees a pick list which is gradually reduced as the user enters additional information. For example, FIG. 10A shows an example of an interface 1410 with such pick list 1420. A user starts to type the characters 1430 of a look-up term in the interface 1410. When the user enters at least three characters, the retrieval system searches the indexing table from the indexing subsystem. The retrieval subsystem selects indices matching the characters 1430 from indexing table 1350, and all medical codes associated with the indices are retrieved and displayed to the user on pick list 1420. For example, pick list 1420 displays medical code 1422 corresponding with entry in Code 1354 and in Index 1352 matching with characters 140 in row 1358 of indexing table 1350. Similarly, medical codes 1424 and 1426 displays codes in table 1350 that correspond to indices matching with characters 1430.

In another example, FIG. 10B shows a user is looking up the code “G30” in the retrieval subsystem. The user types in characters 1450 with values “G30” and all look-up terms associated with the code appears on the pick list presented on the display. These lookup terms include standard definitions as well as unique terms that the collection subsystem collected for association with the code. As a result, entry 1452 with value “HIF” is displayed as a result of the dynamic search. This is made possible by the comprehensive dictionary created by collecting and assimilating the site specific term “Decreased HIF” to code “G30.0” in the system.

An application would require the user to select one of the entries in the pick list and the client system would then use that information according to the client system's requirements. The retrieval Subsystem uses historical usage data to control the order in which results are displayed. For example, this type of data may be stored along with the index and medical code combination in the indexing table 1850. This information may also be stored in a separate table associated with retrieval subsystem 1400. Entries that have been retrieved more frequently appear at the beginning of the list of results. Those least frequently retrieved appear at the end. Counts of retrievals are done within specific time intervals (for example over the course of a calendar month). Average counts are determined by taking the average number of retrievals within each time interval over the range of time intervals in the sample. Calculating retrieval rates this way allows for more recent retrieval rates to be weighted more heavily. The system may incorporate use of a statistical tool such as an Exponential Moving Average (EMA), a statistic adapted from the financial industry to determine the weight. The formula is as follows:

EMA=Countₜ*k+EMAₜ₋₁*(1−k), where:

t=the current time period, t−1=the previous time period, N=number of time periods, and k=2/(N+1).

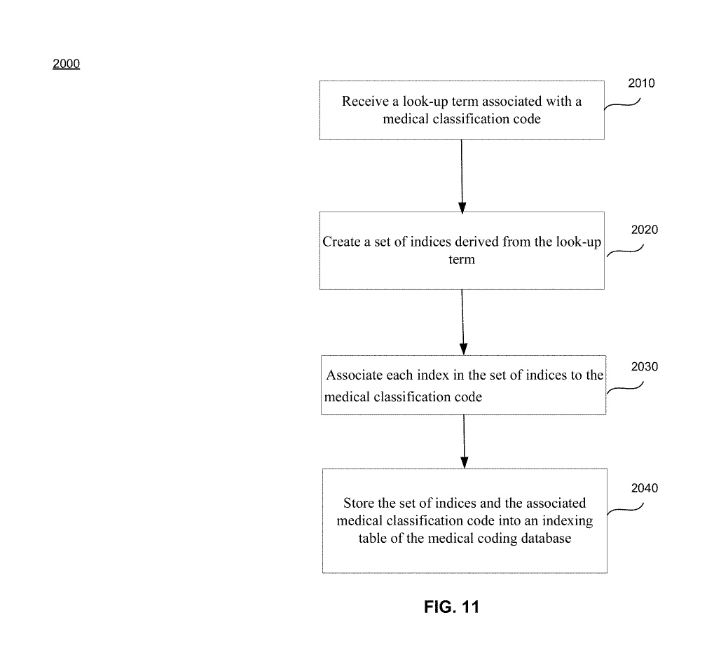

In addition to the operations described above, FIG. 11 shows a flow diagram illustrating an example method 2000 for searching a medical coding database.

At block 2010, a particular look up term associated with a particular medical classification code is received. For example, the particular look up term may contain one or more words. The particular look-up term may be a unique term, such as unique words, acronyms, phrases, slangs, etc. that clinical practitioners use in their day to day activities to describe diseases and procedures. The use of the particular term may depend on the context, working environment, disease state, technical system or sites used, source of the clinical documents, etc.

At block 2020, a set of indices derived from the particular look up term is created. For example, each index in the set of indices may include a string containing at least three contiguous characters from the particular look up term. The first character of the string may be the first character of one of the one or more words of the particular look up term. In another example, the string may contain at least two or more contiguous characters from the particular look up term.

At block 2030, each index in the set of indices is associated to the particular medical classification code.

At block 2040, the set of indices and the associated particular medical classification code is stored into an indexing table of the medical coding database. For example, the indexing table may include a many-to-many relationship between indices and medical classification codes.

Although the present technology is a system and method for automatic assignment of medical codes to unformatted or un-coded document data, which is particularly well suited for implementation as an independent software systems and shall be so described, the present technology is equally well suited for implementation as a functional/library module, an applet, a plug in software application, as a device plug in, and in a microchip implementation.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A computer implemented method implemented on a non-transitory readable storage medium to control a processor for reducing errors in searching a medical coding database, the method comprising:
receiving, by one or more processors, a particular look-up term associated with a particular medical classification code, the particular look-up term including one or more words;
creating, by the one or more processors, a set of indices derived from the particular look-up term, wherein each index in the set of indices comprises a string containing at least three contiguous characters from the particular look-up term, the first character of the string being the first character of one of the one or more words of the particular look-up term;
associating, by the one or more processors, each index in the set of indices to the particular medical classification code; and
storing, by the one or more processors, the set of indices and the associated particular medical classification code into an indexing table of the medical coding database.

2. The computer implemented method of claim 1, further comprising:
retrieving, by one or more processors, at least one resulting medical classification code in response to an input received through a client interface, wherein the input equals to at least one matching index in the indexing table and wherein the at least one resulting medical classification code is associated with the at least one matching index.

3. The computer implemented method of claim 2, further comprising:
displaying, by one or more processors, the at least one resulting medical classification code on the client interface.

4. The computer implemented method of claim 3, wherein historical usage data is used to control the order of display of the at least one resulting medical classification code on the client interface.

5. The computer implemented method of claim 1, wherein the indexing table includes a many-to-many relationship between indices and medical classification codes.

6. The computer implemented method of claim 1, further comprising:
prior to receiving the particular look-up term, storing, by one or more processors, the particular look-up term in a medical coding corpus.

7. The computer implemented method of claim 1, further comprising:
prior to storing the particular look-up term in the medical coding corpus, collecting, by one or more processors, a set of candidate look-up terms, the set of candidate look-up terms including the particular look-up term.

8. The computer implemented method of claim 7, wherein collecting the set of candidate look-up terms includes associating candidate medical classification codes to the set of candidate look-up terms.

9. The computer implemented method of claim 8, wherein the set of candidate look-up terms are associated to candidate medical classification codes using a medical document.

10. The computer implemented method of claim 7, further comprising:
applying, by one or more processors, a first filter configured to determine whether a combination of the particular look-up term and the particular medical classification code does not exist in the medical coding corpus.

11. The computer implemented method of claim 7, further comprising:
applying, by one or more processors, a second filter configured to determine whether a combination of the particular look-up term and the particular medical classification code was not previously rejected as candidate combination.

12. The computer implemented method of claim 11, wherein the second filter uses a rejection table comprising previously rejected combinations of candidate look-up terms and candidate medical classification codes.

13. The computer implemented method of claim 7, further comprising:
applying, by one or more processors, a third filter configured to determine whether a combination of the particular look-up term and the particular medical classification code is valid.

14. An automated system for searching a medical coding database, the system comprising:
one or more processors; and
a memory accessible by the one or more processors, the memory including instructions executable by the one or more processors, the instructions configured to:
receive a particular look-up term associated with a particular medical classification code, the particular look-up term including one or more words;
create a set of indices derived from the particular look-up term, wherein each index in the set of indices comprises a string containing at least three contiguous characters from the particular look-up term, the first character of the string being the first character of one of the one or more words of the particular look-up term;
associate each index in the set of indices to the particular medical classification code; and
store the set of indices and the associated particular medical classification code into an indexing table of the medical coding database.

15. The automated system of claim 14, wherein the instructions are further configured to:
retrieve at least one resulting medical classification code in response to an input received through a client interface, wherein the input equals to at least one matching index in the indexing table and wherein the at least one resulting medical classification code is associated with the at least one matching index.

16. The automated system of claim 15, wherein the instructions are further configured to:
display the at least one resulting medical classification code on the client interface.

17. The computer implemented method of claim 16, wherein historical usage data is used to control the order of display of the at least one resulting medical classification code on the client interface.

18. The computer implemented method of claim 14, wherein the indexing table includes a many-to-many relationship between indices and medical classification codes.

19. A non-transitory computer readable storage medium comprising instructions executable by one or more processors to:
receive a particular look-up term associated with a particular medical classification code, the particular look-up term including one or more words;
create a set of indices derived from the particular look-up term, wherein each index in the set of indices comprises a string containing at least three contiguous characters from the particular look-up term, the first character of the string being the first character of one of the one or more words of the particular look-up term;
associate each index in the set of indices to the particular medical classification code; and
store the set of indices and the associated particular medical classification code into an indexing table of the medical coding database.

20. The non-transitory computer readable storage medium of claim 19, further comprising instructions executable by one or more processors to:
retrieve at least one resulting medical classification code in response to an input received through a client interface, wherein the input equals to at least one matching index in the indexing table and wherein the at least one resulting medical classification code is associated with the at least one matching index.
